(19) United States
(12) Patent Application Publication
(10) Pub. No.: US 2012/0120063 A1
(43) Pub. Date: May 17, 2012

(54) IMAGE PROCESSING DEVICE, IMAGE PROCESSING METHOD, AND PROGRAM

(75) Inventor: Koji Ozaki, Kanagawa (JP)

(73) Assignee: SONY CORPORATION, Tokyo (JP)

(21) Appl. No.: 13/288,228

(22) Filed: Nov. 3, 2011

(30) Foreign Application Priority Data
Nov. 11, 2010 (JP) P2010-253149

(51) Int. Cl. G06T 15/00

(52) U.S. Cl. 345/419

(57) ABSTRACT

An image processing device includes an input section where performing of input of an operation on a display image is possible using a multi-viewpoint image, a parallax detection section which detects the parallax of each image which configures the multi-viewpoint image, and a parallax control section which adjusts parallax of the multi-viewpoint image in a case where it is at least possible to perform an operation on the display image using the input section.

### BACKGROUND

The present disclosure relates to an image processing device, an image processing method, and a program.

In the past, there was a system which provides a stereoscopic video by displaying differing images to the left and right eyes. In addition, there was a device where operation on a display screen is possible using a touch panel or the like.

### SUMMARY

In displaying a stereoscopic image, it is possible to see objects (jump out) in front of the display unit. In addition, in an input device where a display unit and an input unit are combined, such as a touch panel, it is possible to further increase the operation feel since a user obtains a feeling of directly operating a displayed object.

However, in a case of operating a stereoscopic image using a touch panel, when the stereoscopic image and a finger (or a pen or the like) which operates the touch panel overlap, there are cases where an unnatural feeling is imparted to the user, or an unpleasant sensation or a sense of incongruity is created. For example, in a case of operating an image with a portion which is displayed to jump out in front of a display surface (toward a user) using a stereoscopic image, when the finger, the pen, or the like approaches the display unit, originally, the portion which is displayed in front of the display unit is hidden by the finger, the pen, or the like which is positioned above the display unit, and the object, which is positioned in front of the display surface with binocular parallax, is hidden behind the finger in a mutually concealing relationship with the finger, and there is a problem that an unpleasant sensation is imparted to the user.

In addition, in the screen of the touch panel, it is possible to easily perform enlargement, reduction, or the like of the screen, but when enlarging, there is a possibility that parallax which exceeds the binocular width is generated in the display unit. In this case, an object which is originally to be one object is not able to be recognized by a user as one object and is recognized as two objects due to the parallax which exceeds the binocular width and there is a problem that an unpleasant sensation is imparted to the user.

In Japanese Unexamined Patent Application Publication No. 2002-92656, a technology is disclosed where it is intended that an icon image is more indented than a normal state when a mouse cursor is overlapped with the icon and the mouse is pressed. However, in a case of an icon, it is possible that the icon is set in advance so as not to be displayed in front of the display unit since the icon is displayed in a predetermined position and in a predetermined format, but in a case of an image, there is a variety of video sources, such as images captured by another device or images captured to be displayed, in front of the display due to setting by a user. As a result, the operating of an image by a user and the stereoscopic image overlap and there is a problem that an unnatural feeling or a sense of incongruity is imparted to the user.

Therefore, it is desirable that a novel and improved image processing device, image processing method, and program are provided where there is no generation of a sense of incongruity for the user in a case of overlapping of an operation of a screen by the user and an image with a plurality of viewpoints.

According to an embodiment of the disclosure, an image processing device is provided with an input section where performing of input of an operation on a display image is possible using a multi-viewpoint image, a parallax detection section which detects the parallax of each image which configures the multi-viewpoint image, and a parallax control section which adjusts parallax of the multi-viewpoint image in a case where it is at least possible to perform an operation on the display image using the input section.

In addition, a display section, which displays the display image by irradiating light of the display image, may be further provided.

In addition, the parallax control section may adjust the parallax so that an image, which is seen in front of a display surface which irradiates the light of the display image, is seen on the display surface based on the parallax detected by the parallax detection section.

In addition, the parallax control section may adjust the parallax of an image which is seen in front of the display surface and adjust the parallax so that another image is also moved to be behind the display surface.

In addition, the parallax control section may modify the parallax so that only an image, which is seen in front of the display surface, is seen on the display surface may not control and the parallax of other images.

In addition, the parallax control section may adjust so that an image, which is seen in front of the display surface which irradiates the light of the display image, is seen behind the display surface based on the parallax detected by the parallax detection section.

In addition, the parallax control section may adjust the parallax of the multi-viewpoint image to zero and set the multi-viewpoint image as a two-dimensional image in a case where it is at least possible to perform an operation on the display image using the input section.

In addition, a proximity detection section may be provided which detects that a finger of an operator or an operating object is in the proximity of the display surface which irradiates the light of the display image, and the parallax control section may adjust the parallax of the multi-viewpoint image in a case where the finger of the operator or the operating object is in the proximity using the proximity detection section.

In addition, the input section may be configured from a capacitance touch sensor which is provided on the display surface, and the proximity detection section may be configured from the touch sensor and may detect that the finger of the operator or the operating object is in the proximity based on a change in capacitance.

In addition, the parallax detection section may determine whether or not a normal display is possible as a result of the adjustment of the parallax by the parallax control section, and the image processing device may further include an image processing section which reduces the display image in a case where it is determined by the parallax detection section that normal display is not possible.

In addition, the image processing section may reduce the image so that the parallax is equal to or less than the space between the eyes of a person in a case where it is determined by the parallax detection section that normal display is not possible.

In addition, the parallax control section may adjust the parallax of the multi-viewpoint image in a case where it is detected that the display image is to be enlarged due to an operation of the input section.

In addition, the parallax detection section may determine whether or not a normal display is possible as a result of the adjustment of the parallax by the parallax control section, and the image processing device may further include an image processing section which reduces the display image in a case where it is determined by the parallax detection section that normal display is not possible.

In addition, according to another embodiment of the disclosure, an image processing device is provided with an input section where performing of input of an operation on a display image is possible using a multi-viewpoint image, a parallax detection section which detects the parallax of each image which configures the multi-viewpoint image, and a parallax control section which adjusts parallax of the multi-viewpoint image in a case where the size of the display image is equal to or less than a predetermined value and which adjusts parallax so that an image, which is seen in front of a display surface which irradiates light of the display image, is seen on the display surface.

In addition, according to still another embodiment of the disclosure, an image processing device is provided with an input section where performing of input of an operation in the vicinity of a display image is possible using a multi-viewpoint image, a parallax detection section which detects the parallax of each image which configures the multi-viewpoint image, and an image processing section which displays the input section in the vicinity of the display image using a two-dimensional image in a case where it is at least possible to perform an operation on the display image using the input section.

In addition, according to still another embodiment of the disclosure, an image processing method includes obtaining input of an operation performed on a display image displayed on a display section, detecting parallax of each image which configures a multi-viewpoint image, and adjusting the parallax of the multi-viewpoint image in a case where it is at least possible to perform an operation on the display image using the input of an operation.

In addition, according to still another embodiment of the disclosure, a program which is executed by a computer includes obtaining input of an operation performed on a display image displayed on a display section, detecting parallax of each image which configures a multi-viewpoint image, and adjusting the parallax of the multi-viewpoint image in a case where it is at least possible to perform an operation on the display image using the input of an operation.

According to embodiments of the disclosure, it is possible that there is no generation of a sense of incongruity for a user in a case of overlapping of an operation of a screen by the user and an image with a plurality of viewpoints.

### BRIEF DESCRIPTION OF THE DRAWINGS

FIG. 1 is a schematic diagram illustrating a configuration example of an image processing device according to an embodiment of the present disclosure;

FIGS. 2A to 2C are schematic diagrams illustrating an ideal display state in a case where a stereoscopic image is displayed on a display section and a touch panel of the display section is operated using a pen;

FIGS. 3A to 3C are schematic diagrams illustrating a view actually seen by a user in a case where a stereoscopic image is displayed on a display section and a touch panel of the display section is operated using a pen;

FIGS. 4A to 4C are schematic diagrams illustrating a positional relationship of an object “B” and a pen which is the same positional relationship as FIGS. 3A to 3C;

FIG. 5 is a schematic diagram illustrating an example of parallax adjustment;

FIG. 6 is a schematic diagram illustrating an example where an unnatural feeling is imparted to a user in a case where parallax adjustment is performed with the same method of FIG. 5;

FIG. 7 is a schematic diagram illustrating a case of parallax adjustment of only an object C which is seen in front without adjustment of a position of an object D which is seen behind in the case of FIG. 6;

FIG. 8 is a schematic diagram illustrating a case where a plurality of objects is seen in front;

FIG. 9 is a schematic diagram illustrating a case where all objects are displayed on a display surface and a two-dimensional image is displayed;

FIG. 10 is a schematic diagram illustrating an example of displaying using an image with a single viewpoint in a case of a two-dimensional display;

FIG. 11 shows an example where reduction of an image is performed in a case where the parallax is larger than the binocular width as a result of parallax being adjusted;

FIG. 12 shows an example where reduction of an image is performed in a case where the parallax is larger than the binocular width as a result of parallax being adjusted;

FIG. 13 is a schematic diagram illustrating an example of a detection method of the amount of parallax for parallax adjustment;

FIG. 14 is a schematic diagram illustrating an example where an operation frame for a touch panel operation is arranged on an image which is displayed on a display surface of a display section;

FIG. 15 is a schematic diagram illustrating an example where the display sections of FIG. 14 are vertically disposed;

FIG. 16 is a schematic diagram illustrating an example where a proximity detection sensor, which detects whether a pen is in the proximity of a display surface, is also used as a touch panel;

FIG. 17 is a flowchart illustrating actions during an image operation;

FIG. 18 is a flowchart illustrating a process when an image is enlarged due to operation of a touch panel;

FIG. 19 is a flowchart illustrating a process where the enlargement ratio is limited and that enlargement is not possible is displayed when 3D display will not be possible due to the enlargement in a case where the process of FIG. 18 is performed;

FIG. 20 is a flowchart illustrating a process where display is performed so that parallax in all portions are reduced to be smaller than the binocular width after parallax adjustment is performed and a portion which is displayed in front is removed;

FIG. 21 is a flowchart illustrating a process where switching between the cases of FIGS. 17 and 20 is performed;

FIG. 22 is a flowchart illustrating a case where the width of an image is smaller than the binocular width;

FIG. 23 is a flowchart illustrating a process where parallax modification is performed or there is switching to a two-dimensional display in a case where there is a display where a screen is operated using a touch panel or the like;

FIG. 24 is a flowchart illustrating a process where parallax modification is performed or there is switching to a two-dimensional display in a case where operation of a screen using a touch panel or the like is predicted;

FIG. 25 is a flowchart illustrating a process where parallax modification or two-dimensional display is set in a case where an image is smaller than a predetermined size in a case of a display where touch panel operation is possible; and

FIG. 26 is a flowchart illustrating a process in a case where an operation frame is set as described in FIGS. 14 and 15.

### DETAILED DESCRIPTION OF EMBODIMENTS

Below, embodiments of the disclosure will be described in detail while referencing the attached diagrams. Here, in regard to constituent elements which have the same actual functional configuration in the specifications and the diagrams, the same reference numerals are attached and overlapping description is omitted.

Here, the description will be performed in the order below.

1. Configuration Example of Image Processing Device

2. Display of Image Processing Device of Embodiment

3. Process of Image Processing Device of Embodiment

### 1. Configuration Example of Image Processing Device

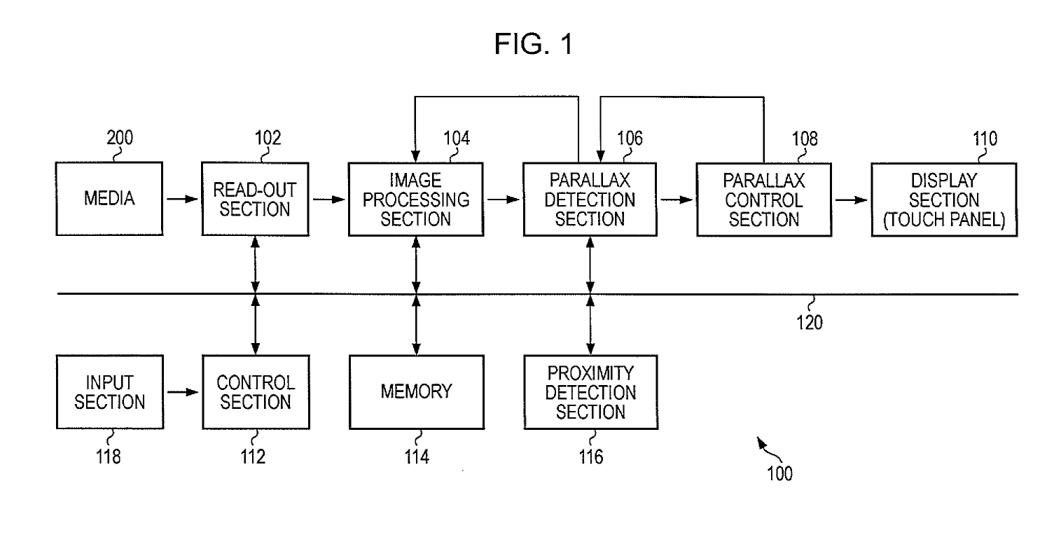

FIG. 1 is a schematic diagram illustrating a configuration example of an image processing device 100 according to an embodiment of the disclosure. The image processing device 100 is, for example, a device which is provided with a comparatively small display and is a device that is able to display stereoscopic images (3D video). The images displayed on the image processing device 100 may be any out of still images or moving images. In addition, in the image processing device 100, various inputs are possible by a user operating a screen in accordance with a display screen. It is possible to realize the image processing device 100 as a digital still camera, a digital video camera, a personal computer (PC), a gaming device, a television reception device, a phone, a PDA, an image reproduction device, an image recording device, a car navigation system, a portable terminal, a printer, or the like.

Here, the method of 3D video is not particularly limited. For example, it is possible to use a system where video for the left eye and for the right eye are respectively provided to the left and right eyes of a user by video for the left eye and for the right eye being displayed alternately in a time series manner and shutter glasses, which are worn by the user over the left and right eyes, opening and closing in synchronization with the display of the video. In addition, a system may be used where left and right video is respectively provided to the left and right eyes of the user using the actions of a polarizing plate without the use of the shutter glasses.

As shown in FIG. 1, the image processing device 100 is provided with a read-out section 102, an image processing section 104, a parallax detection section 106, a parallax control section 108, a display section 110, a control section 112, a memory 114, and a proximity detection section 116. In the read-out section 102, data of the left-eye image and the right-eye image which configure a stereoscopic image are sent from a medium 200. The medium 200 is a recording medium which records stereoscopic image data, and as an example, is mounted from the outside of the image processing device 100. In addition, an input section 118 is a touch panel provided on the display section 110. In the image processing device 100, operational information is input by a user via the input section 118. The information input into the input section 118 is sent to the control section 112. The control section 112 determines whether or not the current mode is a screen where an image is operated (a screen where a touch panel operation is possible) based on the operation of the input section 118.

When describing a basic process of the image processing device 100 based on FIG. 1, first, left and right video data which is sent to the image processing device 100 from the medium 200 is read out by the read-out section 102 and image processing is performed by the image processing section 104. In the image processing section 104, processes which process the image for display are performed such as optimization (resizing) of the size of the left and right image data or adjustment of image quality. The image processing section 104 performs a process of reducing an image in a case such as where the parallax is larger than a binocular width as a result of parallax being adjusted as will be described later.

In the parallax detection section 106, left and right image data is compared and parallax of the left and right video is detected by a technique of detecting a movement vector, block matching, or the like. Then, in the parallax detection section 106, it is detected whether or not the image is positioned in front of the display surface, whether or not there is a portion where lines of sight do not intersect, and the like.

The parallax control section 108 performs a process of modifying the parallax in a case where a touch panel operation of the display section 110 is performed. The parallax control section 108 adjusts the parallax so that there is no portion positioned in front of the display surface and there is no portion where the lines of sight intersect.

The display section 110 is a display which displays stereoscopic images and is configured from a liquid crystal display (LCD) or the like. The image where the parallax has been adjusted by the parallax control section 108 is supplied to the display section 110 and displayed. Here, the display section 110 may be integrated with the image processing device 100 or may be a separate device. In addition, the display section 110 is provided to be integrated with a touch panel (touch sensor) which is the input section 118. It is possible for a user to perform a touch panel operation (operation of the input section 118) while visually confirming a stereoscopic image displayed on the display section 110. Here, in a case where it is determined that a finger of the user, a pen, or the like is in the proximity of the display section 110, detection of the proximity is performed using the proximity detection section 116 and a determination is performed using the control section 112. In a case where a capacitance touch sensor or the like where detection of proximity is possible is used as the input section 118, it is possible to use the proximity detection section 116 as the display section 110 and the input section 118 which is the same surface.

The control section 112 is a constituent element which controls the entire image processing device 100 and is configured from a central processing unit (CPU) or the like. The memory 114 is configured from a hard disk, a RAM, a ROM, or the like and stores left and right video data. In addition, it is possible for the memory 114 to store a program for the functioning of the image processing device 100. The proximity detection section 116 detects that the finger of the user, the pen (stylus), or the like is in the proximity of the display section 110 in a case where a touch panel operation is performed by the user. Here, it is possible for the proximity detection section 116 to be configured by a touch panel in a case where the touch panel is configured by a capacitance touch panel which detects capacitance since the proximity of the finger, the pen, or the like is able to be detected by the change in capacitance.

Each of the constituent elements shown in FIG. 1 is connected via a bus 120. It is possible for each of the constituent elements shown in FIG. 1 to be configured by circuits (hardware) or a central processing unit (CPU) and a program (software) for the functioning of the central processing unit.

### 2. Display of Image Processing Device of Embodiment

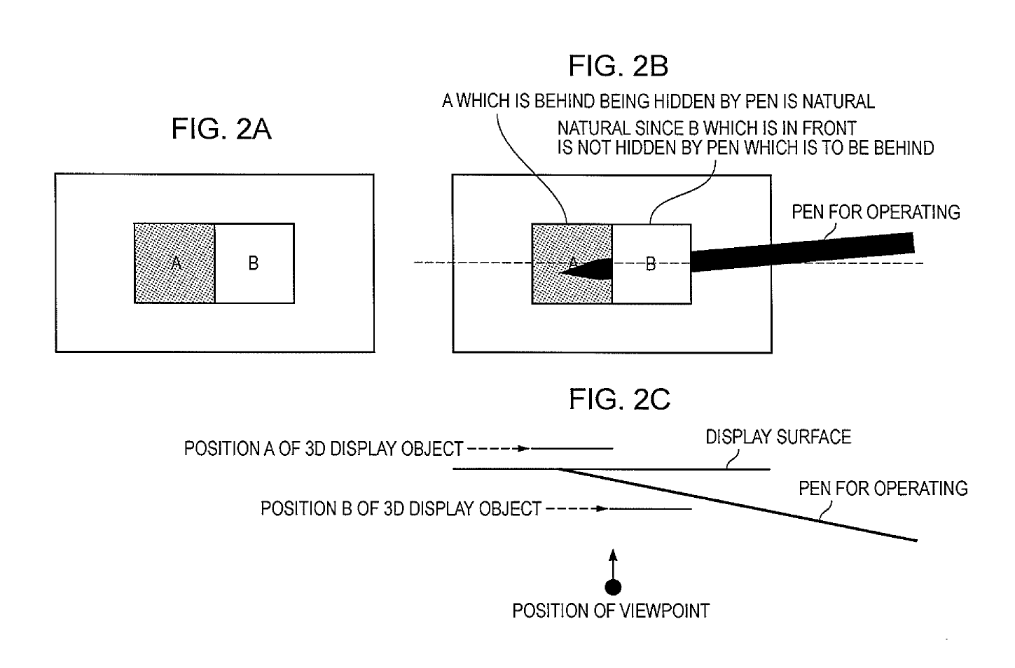

FIGS. 2A to 2C are schematic diagrams illustrating an ideal (natural) display state in a case where a stereoscopic image is displayed on the display section 110 and a touch panel of the display section 110 is operated using a pen. FIG. 2A shows a case where the pen which operates the touch panel does not exist on the display screen of the display section 110 and shows an appearance where a 3D display object “A” is shown on the left of the display section 110 and a 3D display object “B” is shown on the right. In addition, FIG. 2B shows an appearance where the touch panel of the display section 110 is operated by the pen when the stereoscopic video of FIG. 2A is displayed.

In the case of FIGS. 2A and 2B, the portion “B” is displayed (to jump out) in front of the display surface of the display section 110 and the portion “A” is displayed behind the display surface. Since FIG. 2B shows an ideal view of the original positional relationship in a case where the display surface is operated by the pen, “B” is seen in front of the pen which operates the display surface. Accordingly, the pen is hidden behind “B”. On the other hand, since “A” is behind the display surface, “A” is hidden behind the pen. FIG. 2C is a diagram illustrating the positional relationship in the depth direction of “A”, “B”, the display surface, and the pen in FIG. 2B and is a schematic diagram illustrating a state where FIG. 2B is seen from above. As shown in FIG. 2C, the positional relationship from the rear is “A”, the display surface, the pen, and “B” in that order. Accordingly, it is desirable that the original view is such as FIG. 2B.

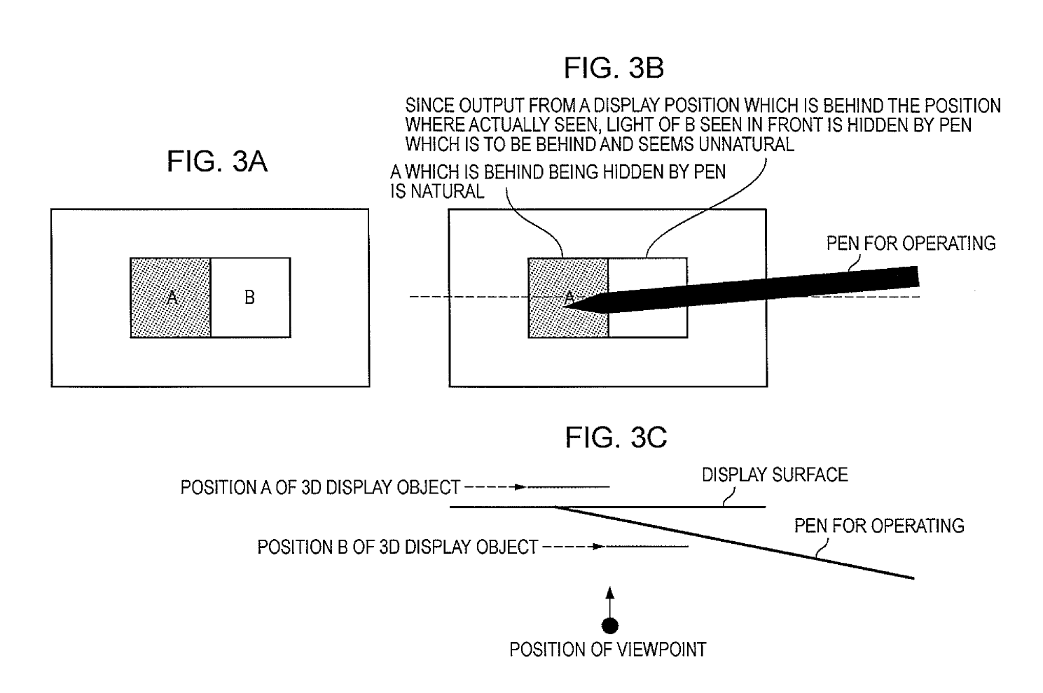

FIGS. 3A to 3C show a view actually seen by the user in a case where a stereoscopic image is displayed on the display section and the touch panel of the display section is operated using the pen. FIGS. 3A and 3C are respectively the same as FIGS. 2A and 2C. FIG. 3B shows a view actually seen by the user in a case where the pen is placed on the 3D display screen. As shown by FIG. 3B, the pen which is originally behind “B” is seen in front of “B” and the pen hides “B”. In a case where the pen does not exist, the user sees “B” in front due to the 3D display, but actual light is emitted from the display surface of the display section 110, and a phenomenon such as this is generated since the display surface is behind the pen. In this case, since the user receives two pieces of conflicting information in the depth direction, there is an unnatural feeling and an unpleasant impression is imparted.

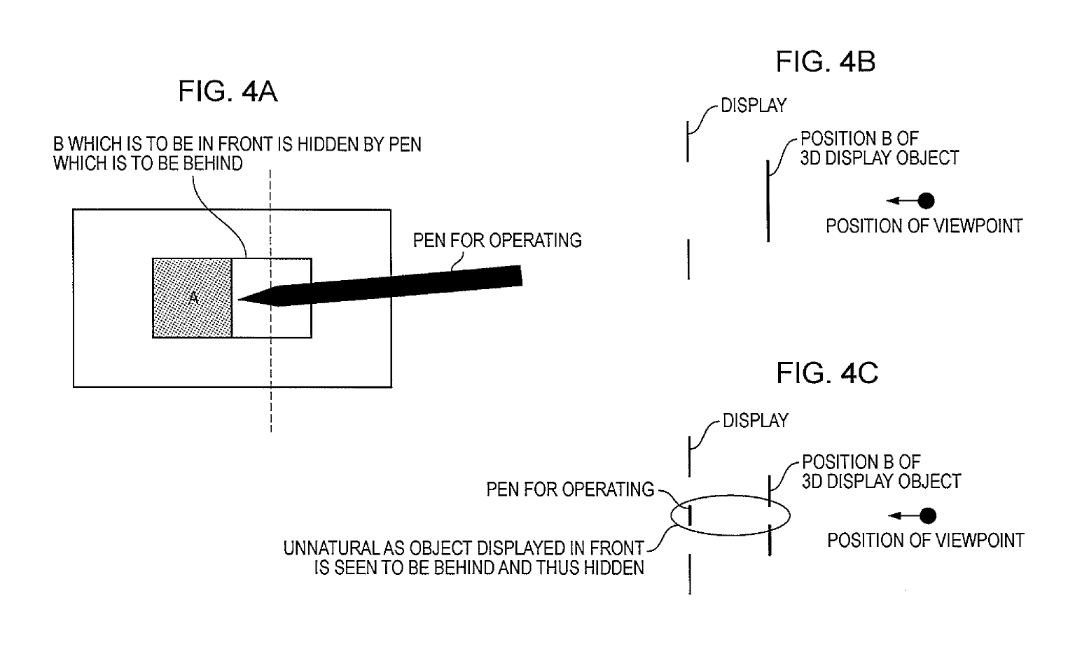

FIGS. 4A to 4C are schematic diagrams illustrating the positional relationship of the object “B” and the pen which is the same positional relationship as FIGS. 3A to 3C. FIG. 4A is a schematic diagram illustrating the view from the user. FIGS. 4B and 4C are diagrams illustrating a positional relationship in the depth direction and show a state where FIG. 4A is seen from a left side surface. FIG. 4B shows the positional relationship in a case where there is no pen, and FIG. 4C shows the positional relationship of the view in a case where there is the pen. As shown by FIG. 4C, in the case where there is the pen, since the video of “B” which is originally to be seen in front of the pen is covered by the pen on the display surface, “B” which is originally to be seen in front of the display surface is seen as though indented in only the region of the pen. In this manner, in a case where an actual object is stereoscopic, the position of the object and the generating source of light emitted from the object is the same position, but in the case of a stereoscopic image, the position where the object appears to be and the position of the generating source of the light do not match, the phenomenon such as this is caused and the user feels that the video is unnatural.

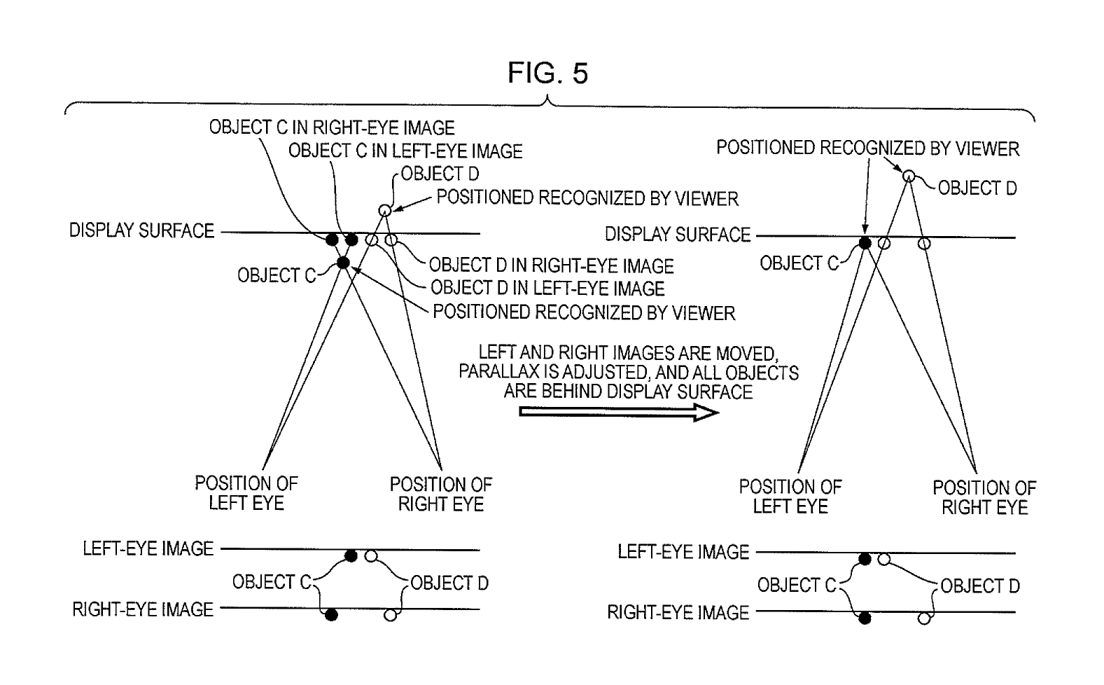

In order to solve the phenomenon such as this, in the embodiment, parallax adjustment is performed in a case where the finger of the user or the pen is on the display surface. FIG. 5 is a schematic diagram illustrating an example of parallax adjustment. The upper part of the diagram of FIG. 5 schematically shows a position in a depth direction when the display surface is seen from above in the same manner as FIG. 2C. In addition, the lower part of the diagram of FIG. 5 shows a display state of objects in each of the left-eye image and a right-eye image. In addition, the left side of the diagram of FIG. 5 shows before parallax adjustment and the right side of the diagram shows after parallax adjustment.

The left side of the diagram of FIG. 5 shows a state before parallax adjustment and one object is seen in front and one object is seen behind (object C (•) and object D (ο)). The parallax of the objects is adjusted, and as in the right diagram, the object C which is seen in front is either in the same position as the display surface of the display section 110 or behind the display surface. Due to this, since there are no objects positioned in front of the display surface, it is possible to prevent an unnatural feeling being generated in the positional relationship of the video and the pen since the pen is positioned in front of the video even in a case where the pen is placed on the display surface.

Describing in more detail, the diagram shown in the upper part of FIG. 5 shows a state where the user and the display section 110 are seen from above, and the positions of the display surface, the right eye and the left eye of the user, the object C, and the object D are shown. In addition, the diagram shown in the lower part shows the left-eye image and the right-eye image displayed by the display section 110. As shown in the upper part of the diagram, when the object C in the right-eye image and the left eye are joined by a straight line and the object C in the left-eye image and the right eye are joined by a straight line, the intersection of the two straight lines is positioned in the depth direction of the object C. In the same manner, when the object D in the right-eye image and the left eye are joined by a straight line and the object D in the left-eye image and the right eye are joined by a straight line, the intersection of the two straight lines is positioned in the depth direction of the object D. Here, the position in the depth direction of the objects is set in the same manner in the other diagrams based on the position of the objects in the left-eye image and the right-eye image and the position of the right eye and the left eye.

In the right side of the diagram of FIG. 5, the position of the left-eye image and the right-eye image is the same with regard to the object C and the object C is displayed on the display surface by the parallax being set to zero. In addition, along with this, since the parallax of the left-eye image and the right-eye image with regard to the object D is larger than the left side of the diagram, the object D is displayed more to the rear with regard to the display surface than the left side of the diagram. In this manner, in the example shown in FIG. 5, by both the display positions of the object C and the object D being moved to the rear, the object C is displayed on the display surface and the object D is displayed in a position more to the rear with regard to the display surface. Accordingly, since the object C and the object D are displayed behind the pen in a case where the pen is placed on the display surface, it is possible to suppress generation of an unnatural feeling, a sense of incongruity, or the like of the user. Here, the object C may also be displayed at a position behind the display surface.

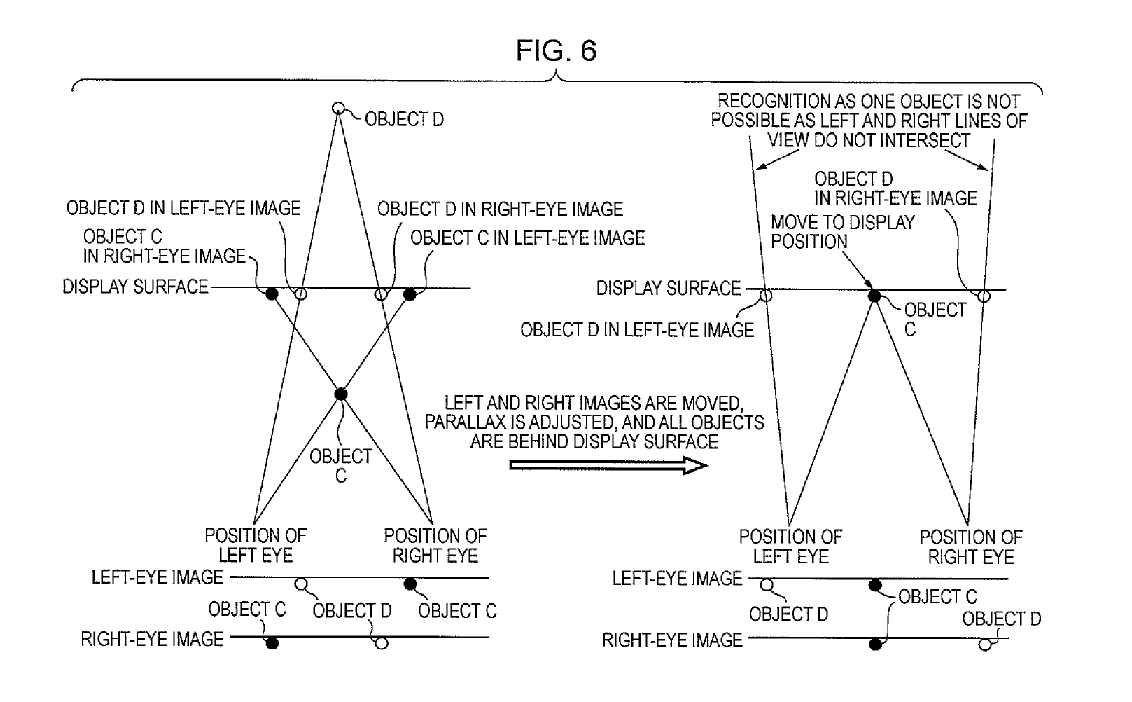

FIG. 6 shows an example where an unnatural feeling is imparted to a user in a case where parallax adjustment is performed with the same method as FIG. 5. The parallax of the images (the object C and the object D) seen in the positional relationship in the left side of the diagram of FIG. 6 is adjusted, the object C is displayed on the display surface using the same method as FIG. 5, and in a case where the object is not able to be displayed in front of the display surface, the images become similar to the right side of the diagram and a portion is generated where there is parallax which is larger than the binocular width.

In more detail, as shown in the lower part of the left side of the diagram of FIG. 6, since the parallax of the object C is set as zero, when the object C and the object D in the left-eye image are moved in the left direction, the parallax of the object D in the left-eye image and the right-eye image becomes excessively large and becomes parallax which is larger than the binocular width. In this case, since the lines of sight of the left and right eyes with regard to the object D do not intersect, the user is not able to recognize the object D as one object and the object D is seen as double in the eyes of the user.

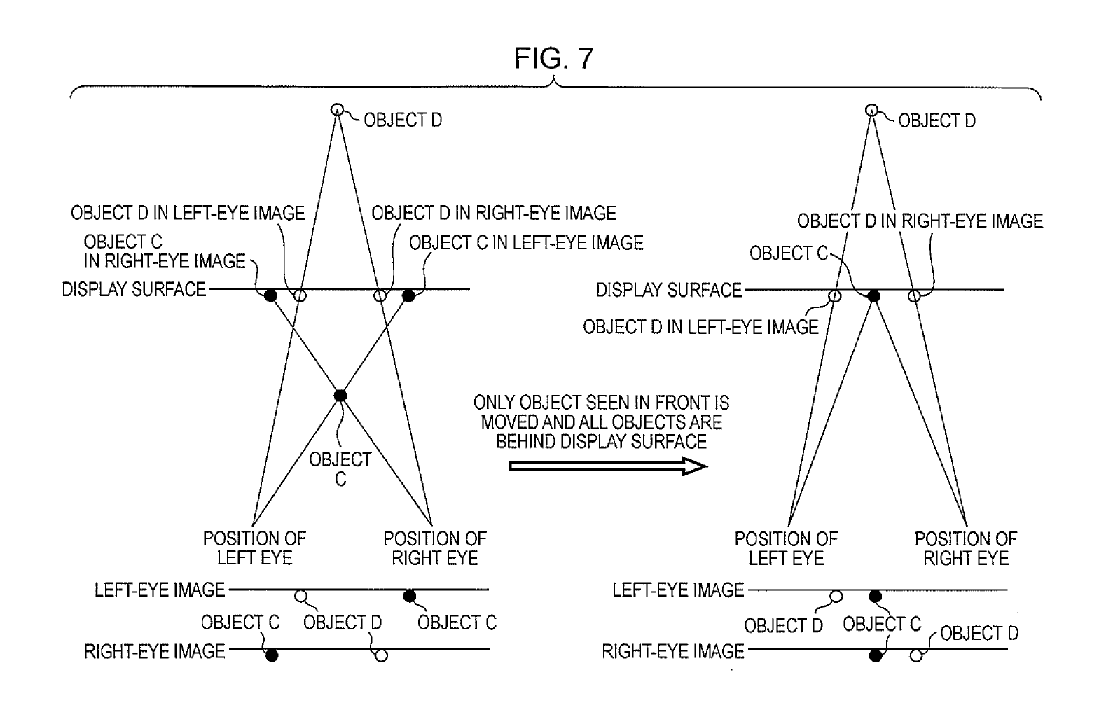

FIG. 7 is a schematic diagram illustrating a case of parallax adjustment of only the object C which is seen in front without adjustment of a position of the object D which is seen behind in the case of FIG. 6. In the left side of the diagram, the object C is seen in front and the object D is seen behind. From this state, in each of the left-eye image and the right-eye image, only the position of the object C is adjusted and the parallax of the object C is set to zero. Specifically, the object C of the left-eye image shown in the left side of the diagram is moved in the left direction and the object C in the right-eye image is moved in the right direction. On the other hand, the position of the object D in the left-eye image and the right-eye image is not changed. Due to this, the object C which is seen in front is seen on the display surface. On the other hand, the object D has its original parallax and is seen in the same position behind the display surface. In this manner, in a case where there is only one object which is seen in front and the other objects are separated in the depth direction, the position of only the object which is seen in front may be adjusted.

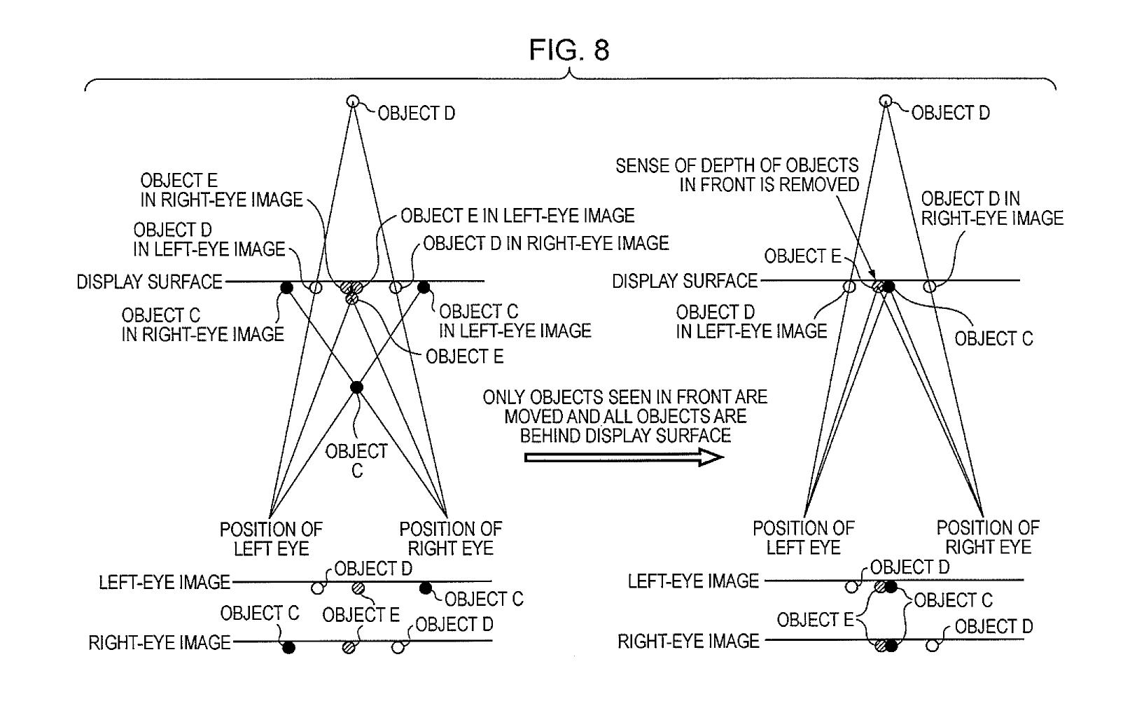

FIG. 8 shows a case where a plurality of objects is seen in front. In the left side of the diagram of FIG. 8, a case is shown where the object C and an object E are seen in front of the display surface and the object D is seen behind the display surface. In this case, the parallax of only the object C and the object E which are seen in front is adjusted, and by the object C and the object E being seen on the display surface, it is possible to prevent generation of a sense of incongruity of the user in a case where the finger of the user, the pen, or the like is positioned on the display surface. Here, when the parallax of all of the objects is not uniformly adjusted and only the parallax of the objects which are seen in front is adjusted, this is referred to as “parallax modification”. On the other hand, when the parallax of all of the objects is adjusted which was already described using FIG. 6 and the like, this is referred to as “parallax adjustment”. In a case where parallax modification is performed as in FIG. 8, since both the object C and the object E, which were originally seen in different positions in the depth direction in front of the display surface, are positioned on the display surface, the mutual sense of depth of the object C and the object E is removed.

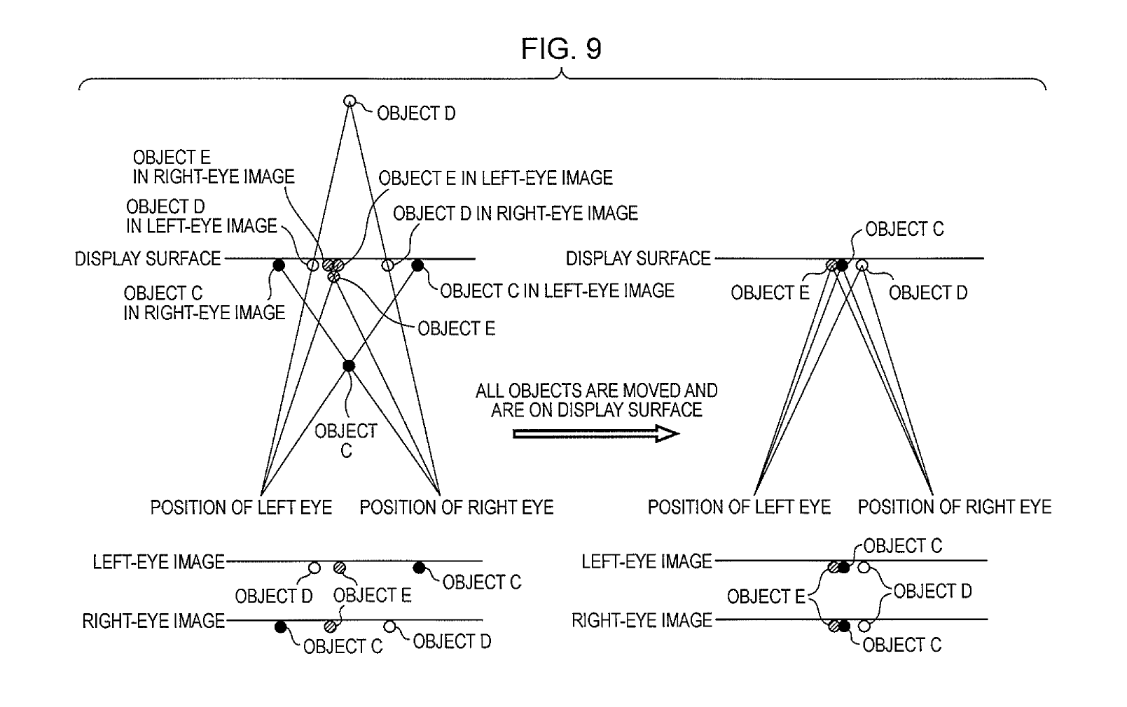

FIG. 9 shows a case where all of the objects are displayed on the display surface and a two-dimensional image is displayed. As described using FIG. 6, in a case where a portion is generated where the parallax is larger than the binocular width when the parallax is adjusted so that an object is not displayed in front of the display surface, parallax adjustment is performed and the video is displayed in a two dimension manner. In the example of FIG. 9, by setting the parallax of each of the object C, the object D, and the object E to zero, the object C, the object D, and the object E are displayed in a two dimension manner. In this case, as shown in the lower part of FIG. 9, the position in the left-eye image and the right-eye image with regard to each of the object C, the object D, and the object E is adjusted and the parallax is set to zero.

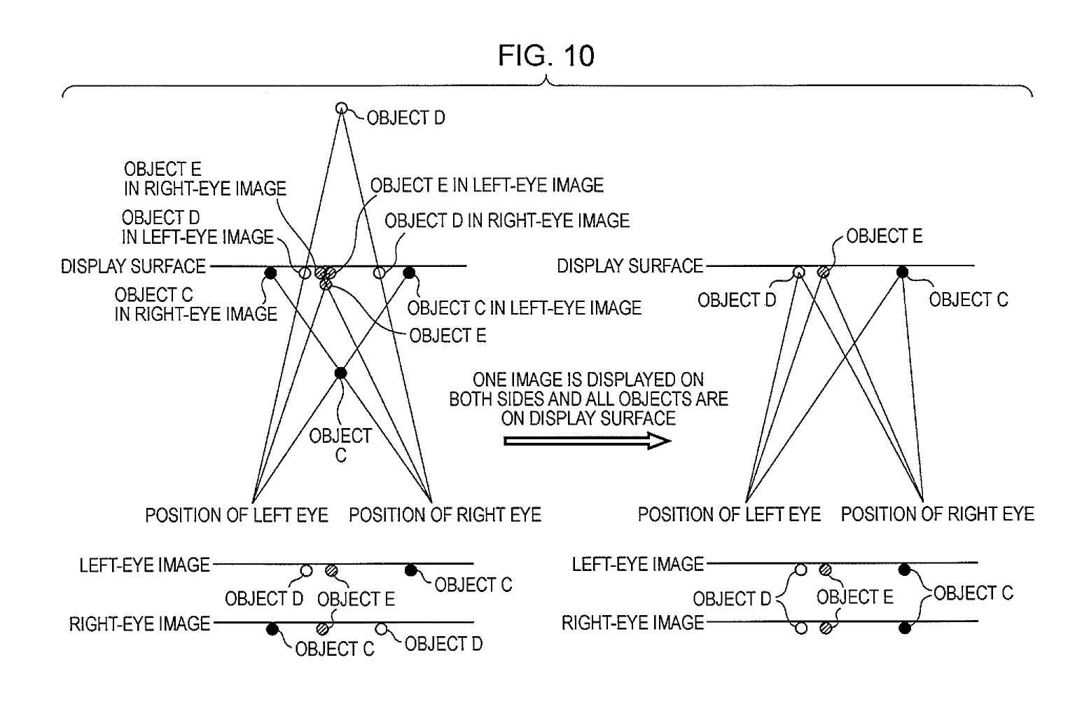

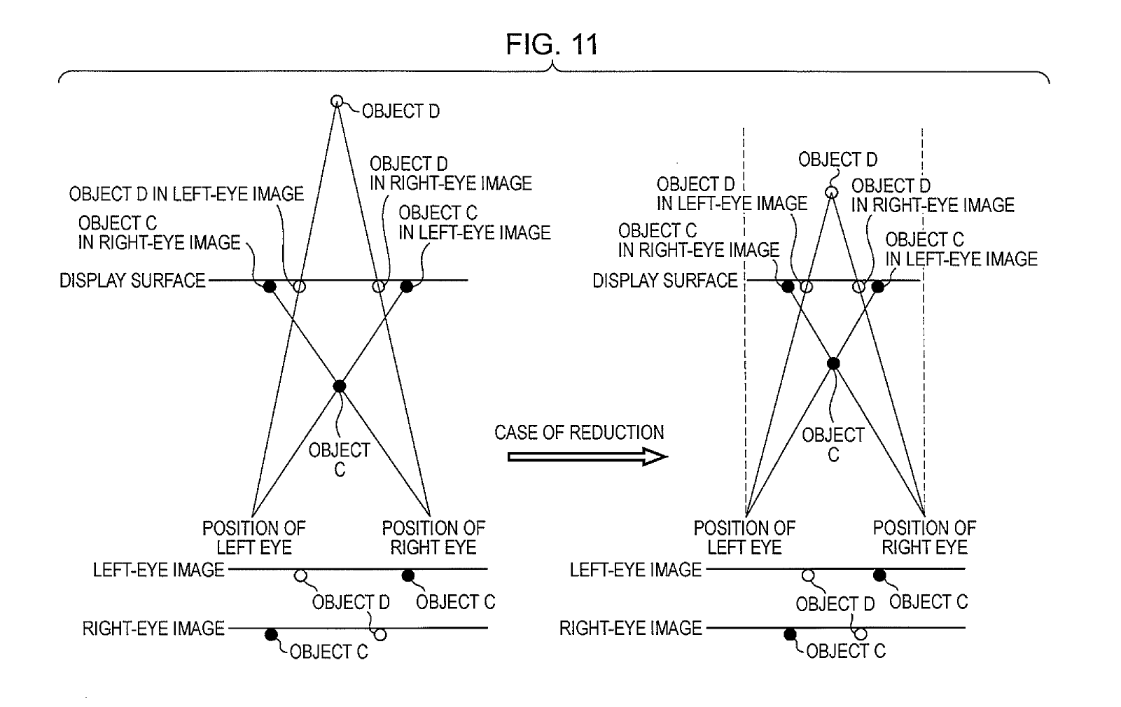

FIG. 10 is a schematic diagram illustrating an example of displaying using an image with a single viewpoint in a case of a two-dimensional display. In the example of FIG. 10, an image which is the same as the left-eye image is displayed as the right-eye image as shown in the lower part of the right side of the diagram. Due to this, it is possible to perform two-dimensional display without particularly adjusting the parallax of the right-eye image and the left-eye image. Accordingly, it is not necessary to perform a process of detecting parallax using block matching or the like and it is possible to display a two-dimensional image with a simpler process compared to the case of FIG. 9.

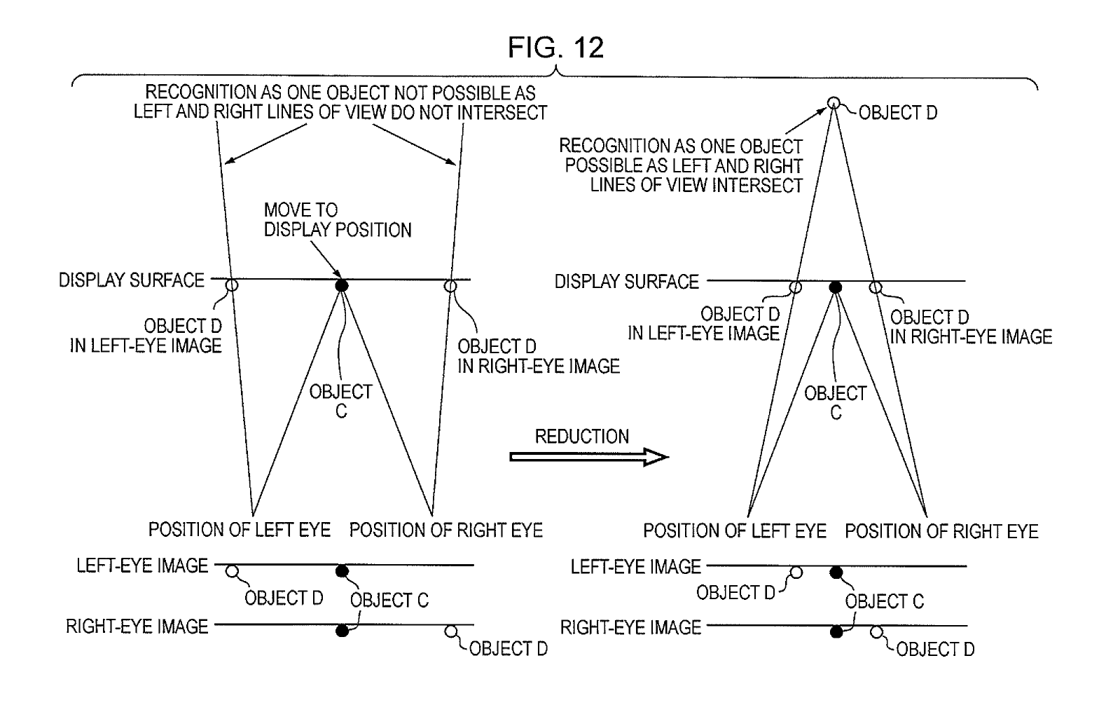

FIGS. 11 and 12 show examples where reduction of an image is performed in a case where the parallax is larger than the binocular width as a result of parallax being adjusted as described in FIG. 6. The right side of FIG. 11 shows a case where the left and right images are both reduced with regard to the left side. As shown in FIG. 11, when the size of the image becomes equal to or less than a constant value, it is not possible to create an image where the lines of sight do not intersect. Accordingly, as described using the right side of the diagram of FIG. 6, a portion, where there is parallax which is larger than the binocular width, is not generated.

The left side of the diagram of FIG. 12 corresponds to the right side of the diagram of FIG. 6 and shows a state where a portion is generated where there is parallax which is larger than the binocular width. The right side of the diagram of FIG. 12 shows a state where the left side of the diagram of FIG. 12 is reduced using the principles of FIG. 11. As shown in the left side of the diagram of FIG. 12 (and the right side of the diagram of FIG. 6), since it is not possible to display a 3D image when the parallax becomes larger than the binocular width as a result of the parallax being adjusted, the left and right images are reduced and the parallax is made to be narrower than the binocular width as shown in the right side of the diagram of FIG. 12. Due to this, it is possible to display a portion displayed in front on the display surface and it is possible to prevent the parallax from becoming larger than the binocular width as shown in the right side of the diagram of FIG. 6. Accordingly, by performing the reduction, it is possible to make the parallax narrower than the binocular width and it is possible to prevent the object being seen as double.

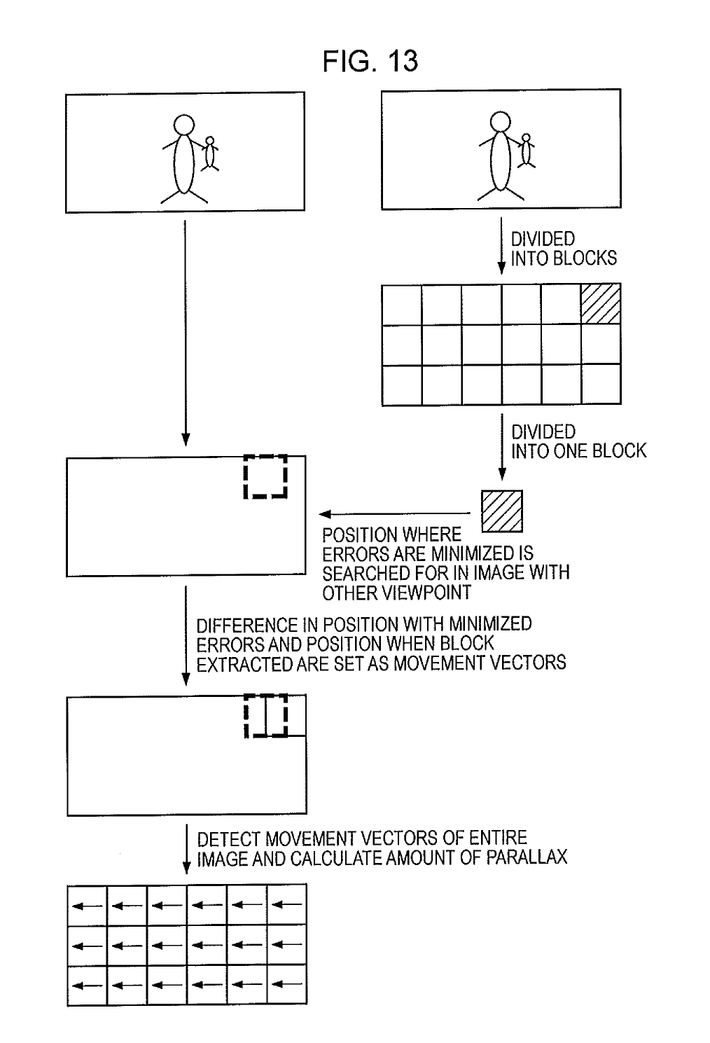

FIG. 13 is a schematic diagram illustrating an example of a detection method of an amount of parallax for parallax adjustment. In a case where one out of two images (the left-eye image and the right-eye image) which determine parallax is divided into blocks and each block is compared to the other image, it is determined between which portions of the other image is the error with each block minimized. Then, the difference between the position on the other image where the errors are minimized and the position of the original block is the amount of parallax. As shown in FIG. 13, the amount of parallax is determined for each block as a vector value. In the example of FIG. 13, the right-eye image is divided up into blocks, each block is compared to the left-eye image, and the position, where the errors between the left-eye image and each block is minimized, is searched for. Then, the difference between the position where the errors are minimized and the position of the block extraction is set as a movement vector and the movement vector is calculated with regard to each block of the entire screen.

In the example of FIG. 13, in a case where the position which corresponds to the left-eye image is misaligned to the left with regard to the block of the right-eye image, the movement vector is a vector which leads from right to left. As shown, for example, in the left side of the diagram of FIG. 5, in a case where the position which corresponds to the left-eye image is misaligned to the left with regard to the block of the right-eye image, the object is displayed behind the display surface (the object D shown in the left side of the diagram of FIG. 5). On the other hand, in a case where the position which corresponds to the left-eye image is misaligned to the right with regard to the block of the right-eye image, the object is displayed in front of the display surface (the object C shown in the left side of the diagram of FIG. 5). Accordingly, in a case where the movement vectors of each block are calculated as shown in FIG. 13, it is understood that the object which corresponds to the block is displayed behind the display surface in a case where the movement vector is a vector leading from right to left and the object which corresponds to the block is displayed in front of the display surface in a case where the movement vector is a vector leading from left to right. In addition, in a case where the movement vector is a vector leading from right to left, the object which corresponds to the block is displayed more to the rear of the display surface as the absolute value of the vector becomes larger. In a case where the movement vector is a vector leading from left to right, the object which corresponds to the block is displayed more to the front of the display surface as the absolute value of the vector becomes larger. Here, the process shown in FIG. 13 is performed using the parallax detection section 106 shown in FIG. 1.

When adjusting the parallax, a block (referred to here as block 1) with the largest absolute value (=A) is extracted from the blocks where the movement vector is a vector leading from left to right. Since the image of the extracted block 1 is positioned the farthest in front, the size of the movement vector of the block is adjusted to “zero”. Then, a process is performed with regard to the other blocks where the movement vector of the block 1 is subtracted from the movement vectors of the other blocks. Due to this, as described in FIG. 6, it is possible to uniformly move the positions of all of the objects in the depth direction toward the rear. Here, in a case where parallax modification is performed as described using FIG. 8, the size of the movement vectors of all of the blocks where the movement vectors lead from left to right are adjusted to “zero”. Here, the adjustment of this parallax is performed using the parallax control section 108 shown in FIG. 1.

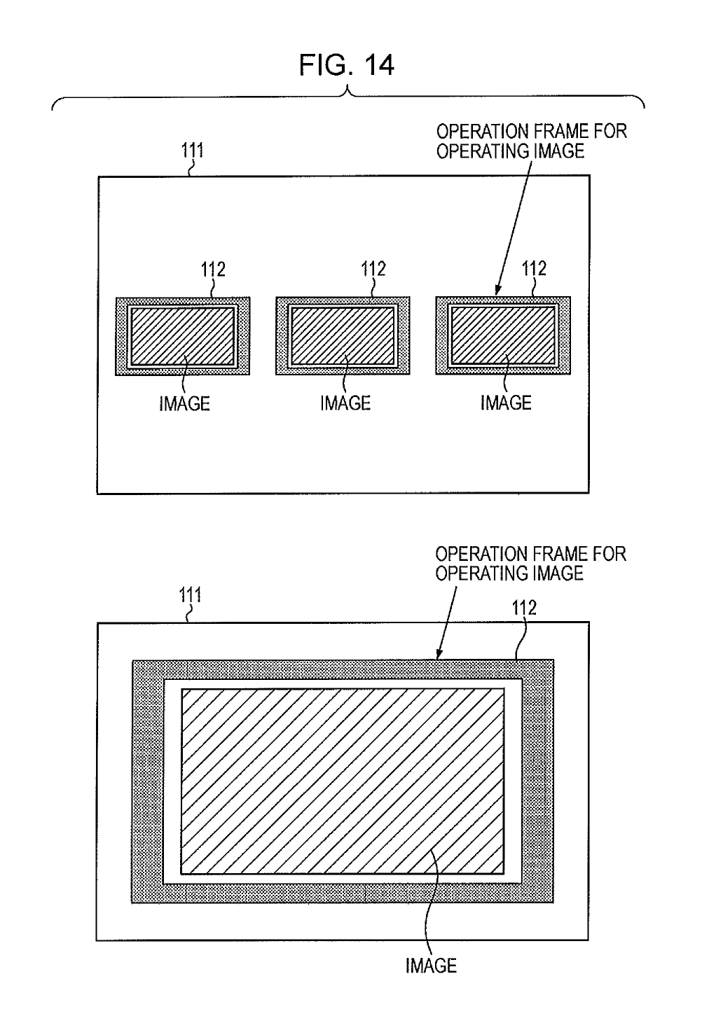

FIG. 14 is a schematic diagram illustrating an example where an operation frame 112 for a touch panel operation is arranged on an image which is displayed on a display screen 111 of the display section 110. Here, the operation frame 112 is displayed as a two-dimensional image. By providing the operation frame 112 outside of the image, in a case where the operation frame 112 is operated by a pen, it is possible to suppress an unnatural feeling and a sense of incongruity due to the image displayed in 3D and the pen overlapping since there is no overlapping with the display region of the image where 3D display is performed. Here, the upper part of FIG. 14 shows an example where a plurality of images in the display screen 111 is displayed in a thumbnail state and the operation frames 112 are provided to surround each image. In addition, the lower part of FIG. 14 shows an example where one image is displayed in the display screen 111 and the operation frame 112 is provided to surround the one image.

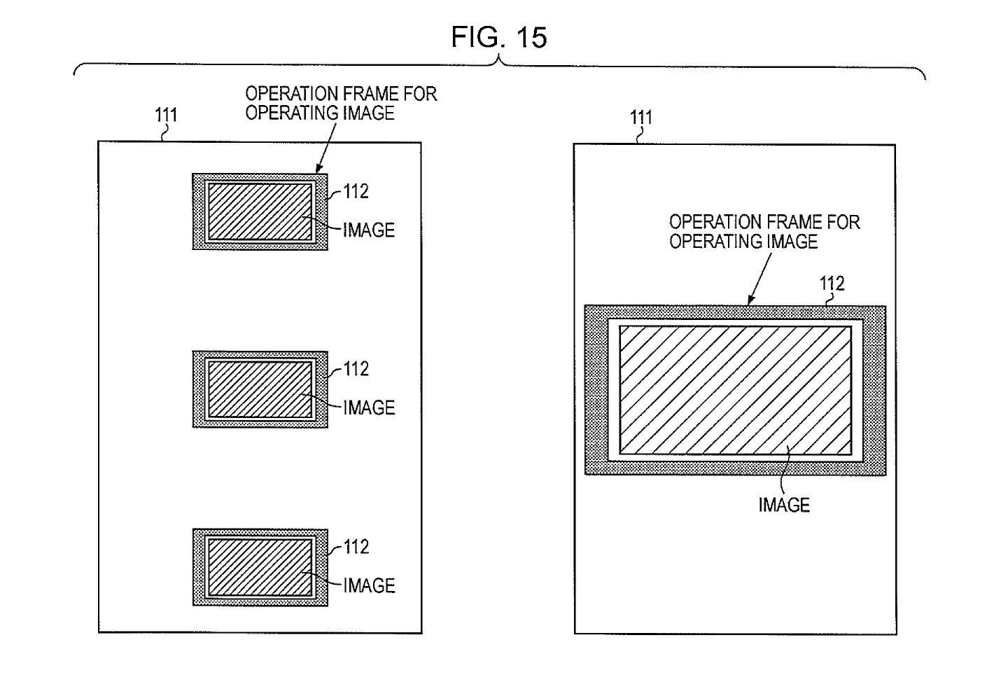

FIG. 15 is a schematic diagram illustrating an example where the display sections 110 of FIG. 14 are vertically disposed. Even in the example of FIG. 15, it is possible to remove the unpleasant sensation since the finger or the pen does not directly touch the 3D image during a touch panel operation.

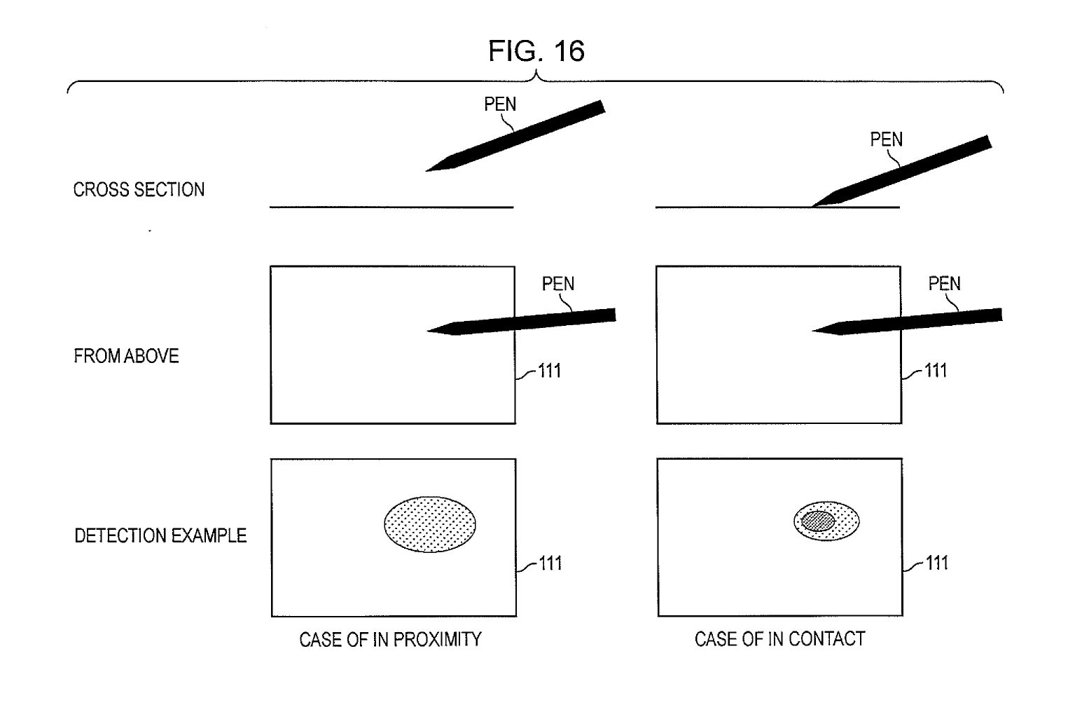

FIG. 16 is a schematic diagram illustrating an example where a proximity detection sensor, which detects whether a pen is in the proximity of the display surface, is also used as the touch panel. For example, in a case where a capacitance touch panel is used, it is possible to use the proximity detection sensor (the proximity detection section 116) also as the touch panel.

The upper part of the diagram of FIG. 16 shows a state seen from a direction parallel to the display surface and shows a case where the pen is in the proximity of or in contact with the display surface. In addition, the middle part of the diagram of FIG. 16 shows a state from above the display surface and shows a case where the pen is in the proximity of or in contact with the display surface. In addition, the lower part of the diagram of FIG. 16 shows a change in capacitance detected by the touch sensor and shows a state where the capacitance of a region where the dots are attached increases in a case where the pen is in the proximity of or in contact with the display surface.

As shown in the lower part of the diagram of FIG. 16, in the process of the pen becoming closer, the capacitance in the location in the proximity of the pen changes and the change in the capacitance becomes larger when the pen touches the display surface. Accordingly, using this, it is possible to determine in what proximity of the display surface the pen is or whether the pen is in contact with the display surface.

### 3. Process of Image Processing Device of Embodiment

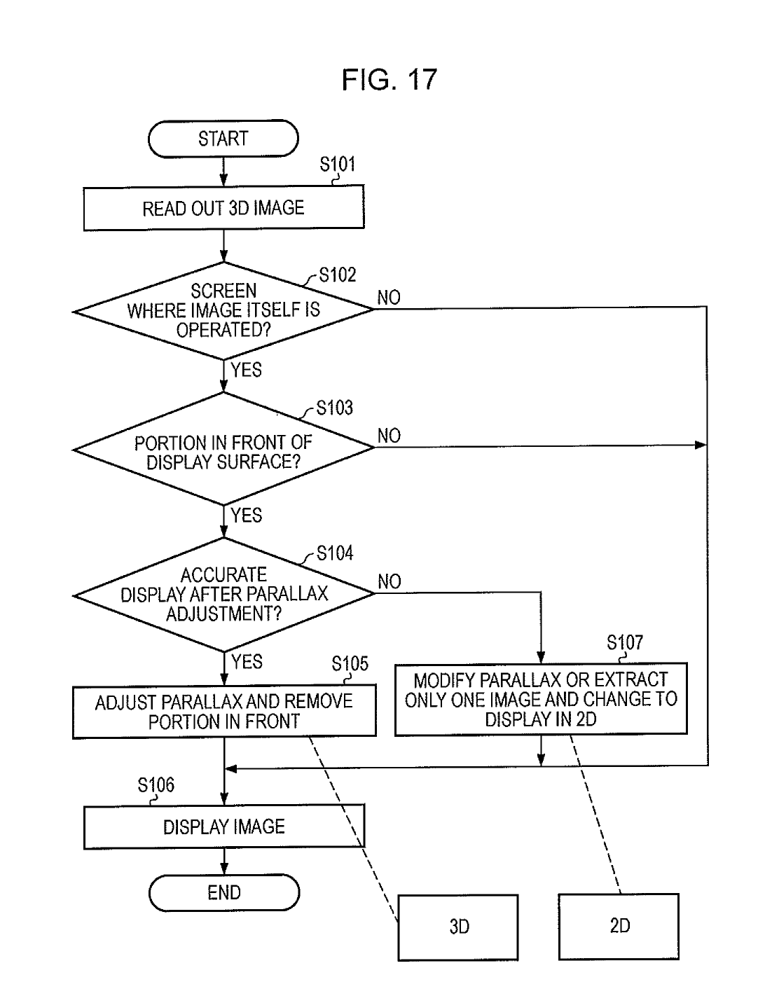

Next, the process according to the image processing device 100 of the embodiment will be described. Here, each of the processes shown below is able to be realized by controlling of the functions of the respective constituent elements of FIG. 1 using the control of the control section 112. FIG. 17 is a flowchart illustrating actions during an image operation. First, in step S101, an image is read out, and in step S102, it is determined whether or not there is a screen where an image is able to be operated. That is, in step S102, it is determined whether or not there is a mode where operation of the screen is possible using a touch panel operation. In this case, in a case where it is detected that the finger of the user, the pen, or the like is brought close to the display surface using the proximity detection section 116, it is possible to determine that there is a mode where operation of the screen is possible using a touch panel operation. In step S102, in a case where it is not a screen where operation is possible, the process proceeds to step S106 and the screen is displayed as it is.

On the other hand, in a case of a screen where operation is possible using a touch panel, the process proceeds to step S103 and it is determined whether there is a portion in front of the display surface. In a case where the setting of changing the modes is performed by an operation by the user, the process proceeds from step S102 to S103 when the screen is set where a touch panel operation is possible, and the process proceeds from step S102 to S106 when the screen is set where a touch panel operation is not possible.

In step S103, it is determined whether or not there is an object which is displayed in front of the display surface using 3D display. Then, in a case where there is no portion which is displayed in front of the display surface, the process proceeds to step S106, and the image is displayed as it is. On the other hand, in a case where there is an object which is displayed in front of the display surface, the process proceeds to step S104 and it is determined whether or not there will be a correct display in a case where the parallax is adjusted. That is, in step S104, in a case where the parallax is adjusted, as shown in the right side of the diagram of FIG. 6, it is determined whether there is a portion where the parallax is larger than the binocular width, and in a case where there will be a correct display, that is, in a case where there is no portion where the parallax is larger than the binocular width, the process proceeds to step S105. In step S105, parallax adjustment is performed so that a portion which is positioned in front of the display surface is displayed on the display surface. Due to this, in step S106, the image is displayed in a state where there are no portions in front of the display surface. On the other hand, in a case where it is determined in step S104 that there will not be a correct display, the process proceeds to step S107, and parallax modification is performed or two-dimensional display is performed using only an image with a viewpoint from one side as is described using FIG. 10. Here, the parallax modification is a process where only a portion seen in front is moved onto the display surface as is described using FIG. 7. Due to this, it is possible to display a 3D image in a state where there are no portions in front of the display surface.

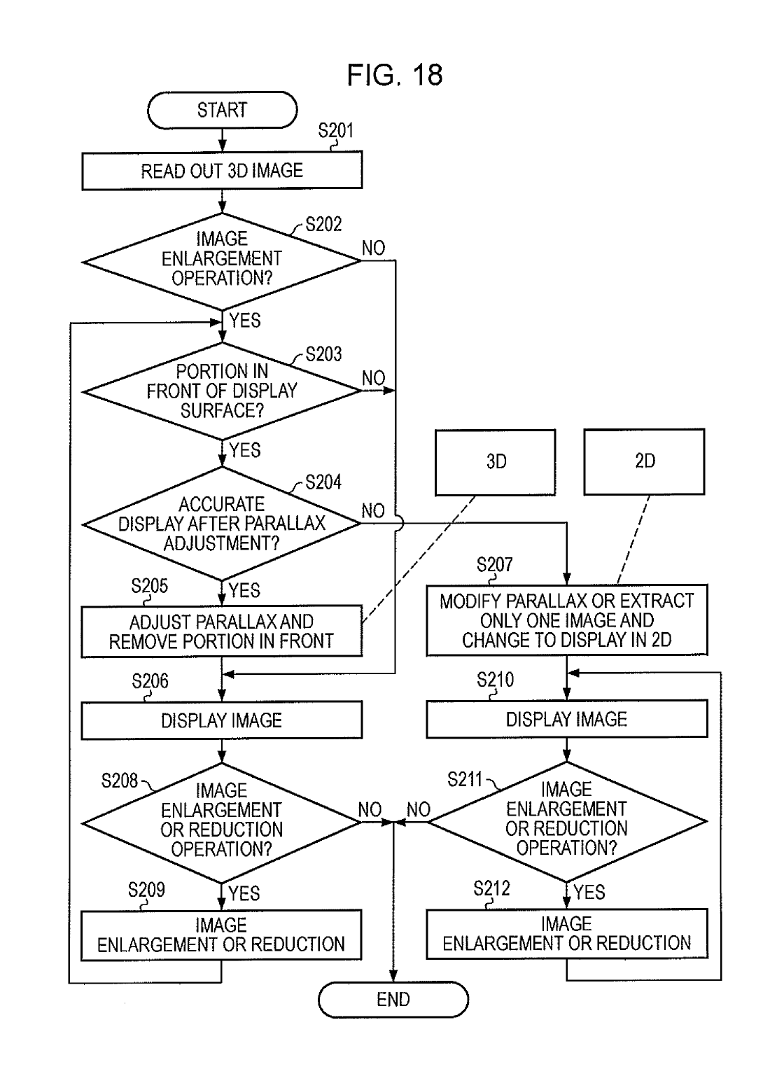

FIG. 18 is a flowchart illustrating a process when an image is enlarged due to operation of a touch panel. When the enlargement of an image is performed, the parallax of the left and right images becomes larger in accordance with the enlargement, and when the parallax is larger than the binocular width, there is a phenomenon where an object is seen as double as is described using FIG. 6. As a result, in the process of FIG. 18, it is determined whether or not a correct display will be performed every time an enlargement operation is performed (step S204) and display is performed using a two-dimensional image in a case where there will not be a correct display. Due to this, in a case where an enlargement operation is performed, it is possible for a normal display to be maintained and the finger of the user or the pen to not overlap with an image displayed in front of the display surface.

In FIG. 17, it is determined in step S102 whether or not there is a screen where the image itself is operated, but in step S202 of FIG. 18, instead of step S102, it is determined whether or not an image enlargement operation has been performed. In a case where an image enlargement operation has been performed, the process proceeds to step S203 and it is determined whether or not there is an object displayed in the enlarged image in front of the display surface. On the other hand, in a case where an image enlargement operation is not performed, the process proceeds to step S206. The processes of step S203 to S207 are the same as that of the step S103 to S107 in FIG. 16. Then, in a case of proceeding from step S202 to step S206, the enlarged image is displayed in step S206. Due to this, it is possible to avoid the object being displayed in a position in front of the display surface in the enlarged image.

In addition, in a case where the rate of magnification of the image is large and there will not be a correct display in step S204 even if the parallax is adjusted, the process proceeds to step S207 and parallax modification or display using 2D is performed. Accordingly, whether or not there will be a correct display is determined in step S204 every time enlargement is performed, and by performing parallax modification or display using 2D in a case where a correct display is not possible, it is possible to suppress the user feeling an unnatural sensation. Here, in a case where parallax modification is performed, as described above, since only the parallax of the object positioned in front of the display surface is modified, the parallax of an object positioned behind the display surface is not modified. Accordingly, as shown in the right side of the diagram of FIG. 6, it is possible to avoid a phenomenon where an object is seen as double.

In addition, in FIG. 18, after step S206, the process proceeds to step S208 and it is further determined whether or not an image enlargement or reduction operation has been performed. Then, in a case where an image enlargement or reduction operation has been performed, the process proceeds to step S209 and image enlargement or reduction is performed. After step S209, the process returns to step S203 onward, and with regard to the image after enlargement or reduction has been performed, it is determined whether or not there is an image positioned in front of the display surface.

In addition, after step S207, the process proceeds to step S211 and it is determined whether or not an image enlargement or reduction operation is to be performed. Then, in a case where an image enlargement or reduction operation is to be performed, the process proceeds to step S212, the image enlargement or reduction operation is performed, and the image after the enlargement or reduction in step S210 is displayed.

As above, according to the process of FIG. 18, when an image is enlarged and 3D display is not possible, it is possible to perform 2D display. Accordingly, in a case where 3D display is not possible due to image enlargement as shown in the right side of the diagram of FIG. 6, since it is possible to switch to 2D display, it is possible to avoid 3D display not being possible as a result of the enlargement.

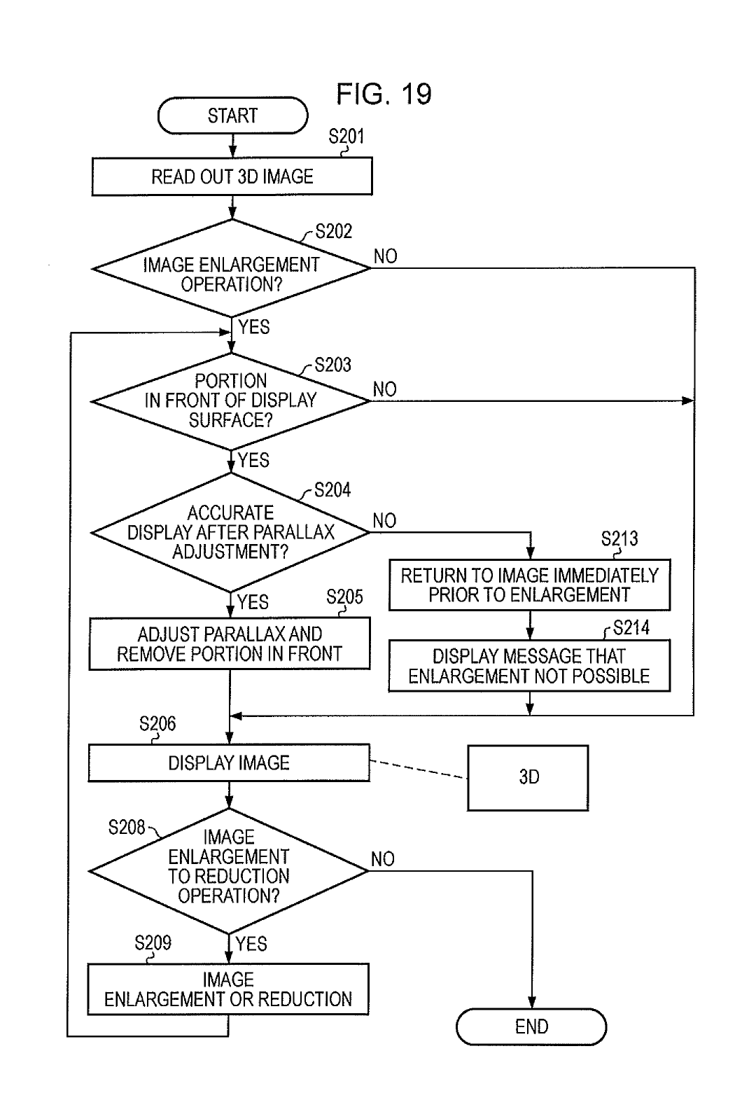

FIG. 19 shows a process where the enlargement ratio is limited and that enlargement is not possible is displayed when 3D display will not be possible due to the enlargement in a case where the process of FIG. 18 is performed. In FIG. 19, the process differs with regard to FIG. 18 in a case where “NO” is determined in step S204. When it is determined in step S204, that there will not be a correct display in a case where the parallax is adjusted, the process proceeds to step S213. In step S213, a process of returning to the image immediately prior to the enlargement is performed. After step S213, the process proceeds to step S214 and a display that enlargement is not possible is performed. Due to this, the user is able to recognize that further enlargement is not possible.

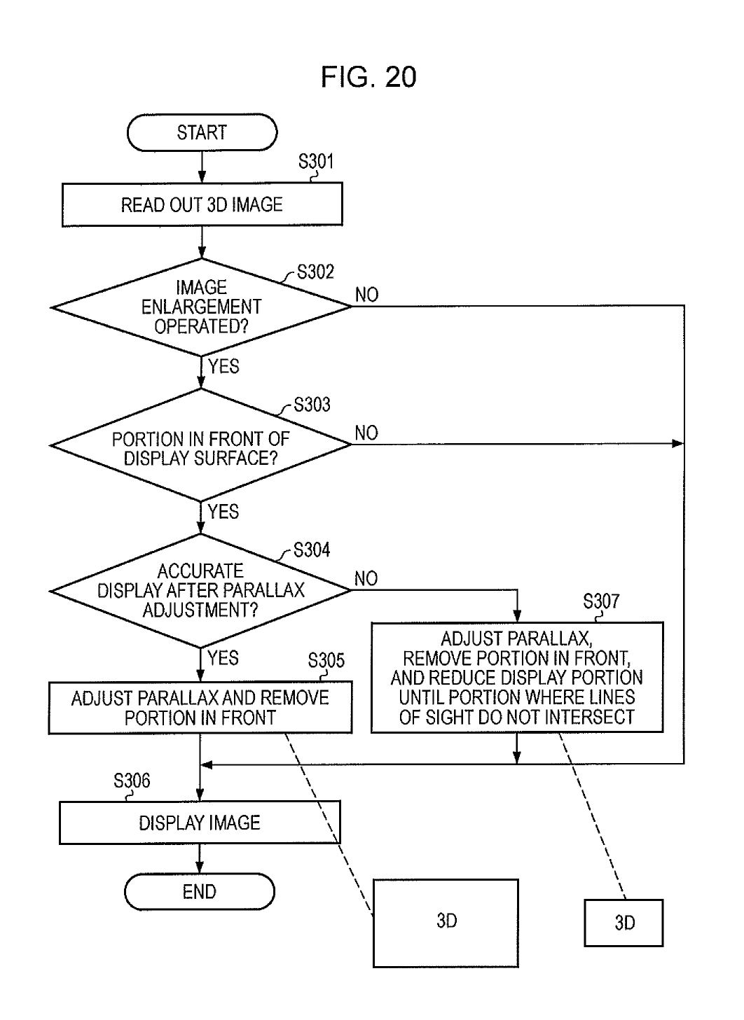

FIG. 20 is a flowchart illustrating a process where display is performed so that parallax in all portions are reduced to be smaller than the binocular width after parallax adjustment is performed and a portion which is displayed in front is removed, instead of performing parallax modification or two-dimensional display described in FIG. 17 in a case where a correct display is not possible. The process corresponds to the display process of FIG. 12. In the process of FIG. 20, the processes other than step S307 is the same as FIG. 17 and step S301 to S306 of FIG. 20 correspond to steps S101 to S106 of FIG. 17. In a case where it is determined in step S304 that there will not be a correct display in a case where the parallax is adjusted, the process proceeds to step S307. In step S307, the parallax is adjusted and a portion which is in front of the display surface is removed, and further, the display portion of the image is reduced until the portion where the lines of sight do not intersect is removed as is described using FIG. 12. Then, in the following step S306, the reduced image is displayed. According to this process, the image is reduced but it is possible to maintain the multi-viewpoint display (stereoscopic display).

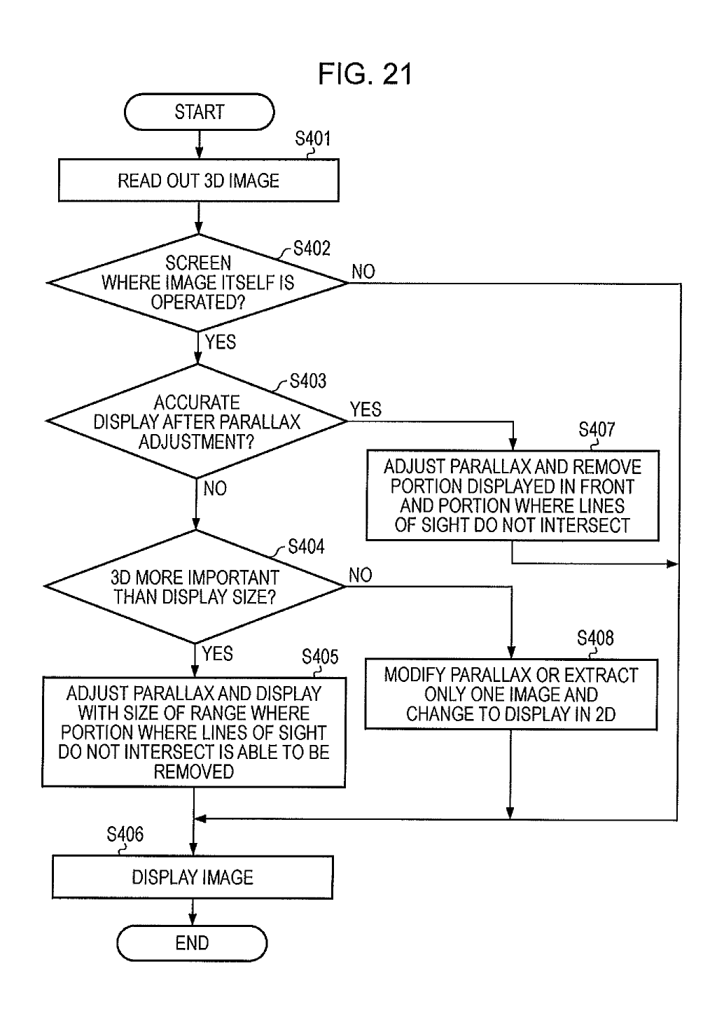

FIG. 21 is a flowchart illustrating a process where switching between the cases of FIGS. 17 and 20 is performed. Here, in a case where there will not be a correct display in a case where the parallax is adjusted, the process proceeds to step S404 and it is determined which out of the display size or 3D display is more important. Then, in a case where 3D display is more important, the process proceeds to step S405, parallax adjustment is performed, and display is performed by reducing to a size where a portion where the lines of sight do not intersect is removed. That is, in this case, the process of step S307 in FIG. 20 is performed. Due to this, the size of the image becomes smaller but it is possible to perform 3D display.

In addition, in step S404, in a case where image size is more important than 3D display, the process proceeds to step S408 and the parallax is adjusted or the display is performed in 2D by extracting only an image from one side. That is, in this case, the process of step S107 of FIG. 17 is performed. In this manner, according to the process of FIG. 21, which out of multi-viewpoint display such as 3D or the size of the image is more important is determined, and whether to adjust the parallax and perform a reduced display or whether to display in a two-dimensional manner (or with parallax modification) is determined. The determination may be set by the user using the input section or may be determined in accordance with a display state on the image processing device 100 side.

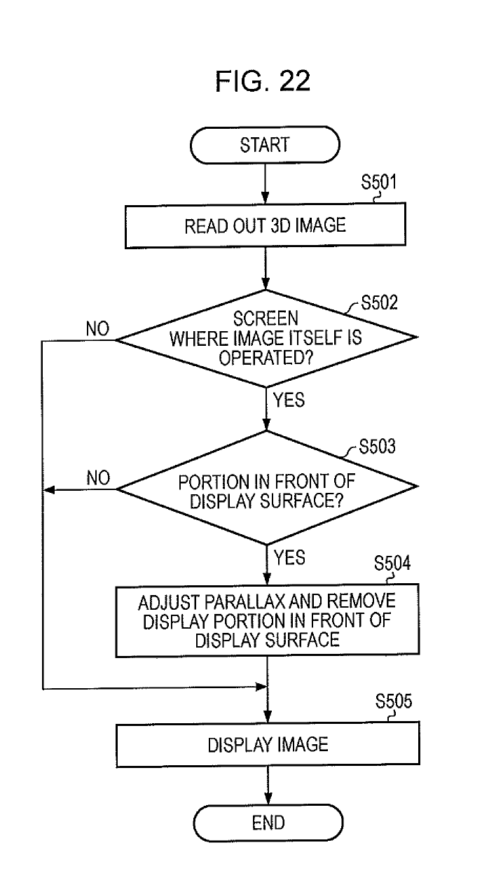

FIG. 22 is a flowchart illustrating a case where the width of an image is smaller than the binocular width. Since a binocular width of a person normally is approximately 5 cm to 7 cm, FIG. 22 is equivalent to a case where the width of an image is equal to or less than approximately 5 cm to 7 cm. In this case, since the width of the image is narrow and a state such as that shown on the right side of the diagram of FIG. 6 does not occur, it is sufficient if a portion displayed in front is moved to the display surface due to parallax adjustment and parallax adjustment is possible. In other words, since a state such as that shown on the right side of the diagram of FIG. 6 does not occur, the process of step S104 of FIG. 17 is not necessary. The other processes are the same as FIG. 17. Here, in this case, since a portion where the lines of sight do not intersect is outside of the width of the image, the portion is not displayed.

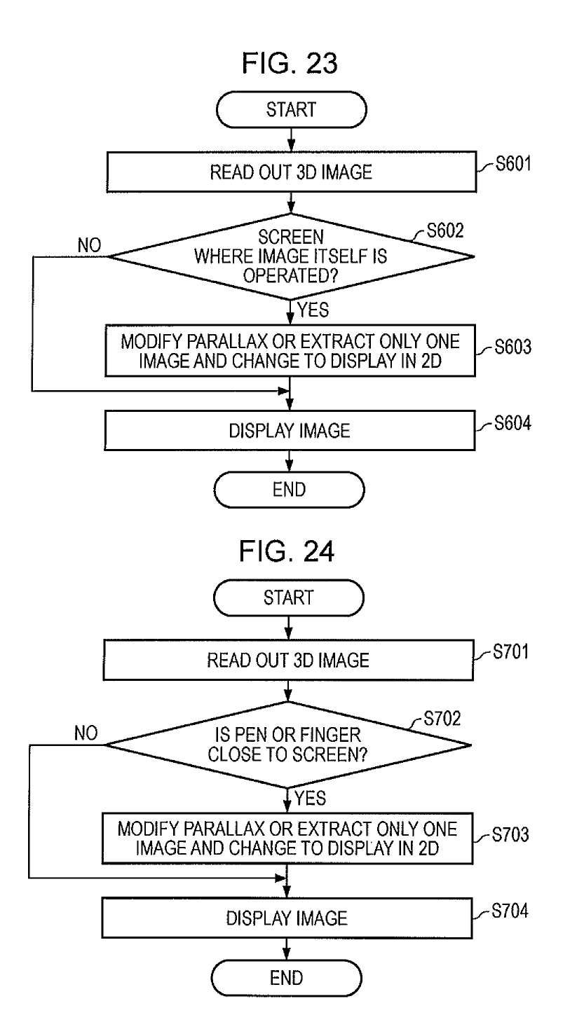

FIG. 23 is a flowchart illustrating a process where parallax modification is performed or there is switching to a two-dimensional display in a case where there is a display where a screen is operated using a touch panel or the like. In step S602, when it is determined that there is a screen where the image itself is operated, the process proceeds to step S603 and parallax adjustment is performed or display in a two-dimensional manner is performed by only an image from one side being extracted. Due to this, since an object displayed in front of the display surface is removed, it is possible to suppress a sense of incongruity occurring in regard to the user during a touch panel operation.

FIG. 24 is a flowchart illustrating a process where parallax modification is performed or there is switching to a two-dimensional display in a case where operation of a screen using a touch panel or the like is predicted. In step S702, when it is detected that a pen or a finger is close to the screen, the process proceeds to step S703 and parallax adjustment is performed or display in a two-dimensional manner is performed by only an image from one side being extracted. In this manner, even in a case where an image operation is not actually being performed, parallax modification or two-dimensional display is performed in a case where operation of a screen is predicted in accordance with the proximity of the finger of the user, the pen, or the like. Here, as described above, the approaching of the pen, the finger, or the like is detected by the proximity detection section 116 or by the capacitance touch panel.

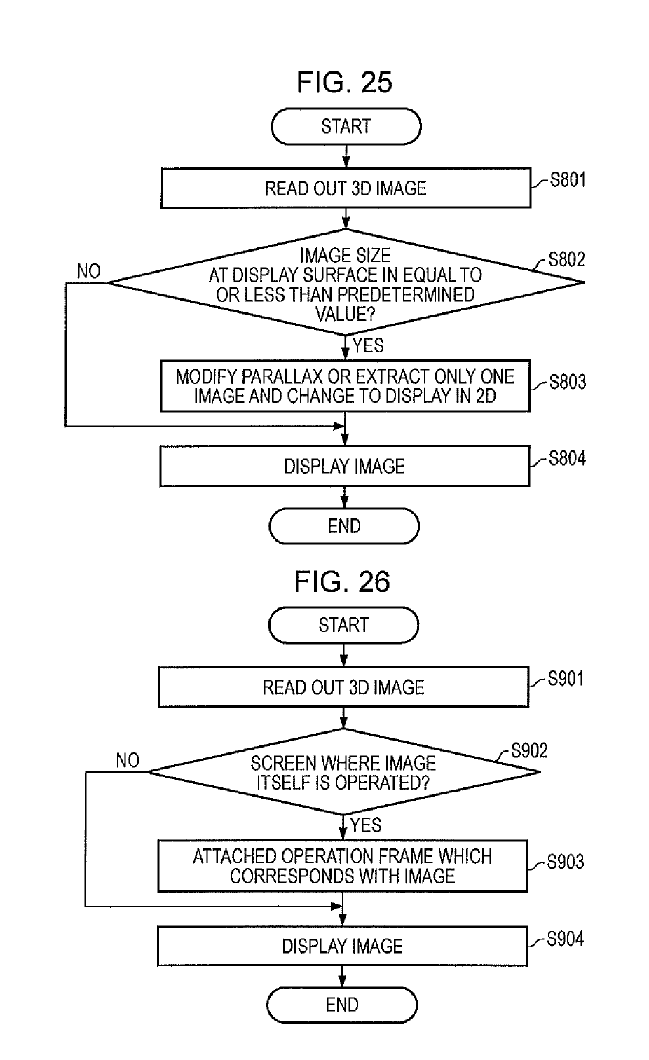

FIG. 25 is a flowchart illustrating a process where parallax modification or two-dimensional display is set in a case where an image is smaller than a predetermined size in a case of a display where touch panel operation is possible. In this manner, for example, since the sense of depth tends to weaken in a case of a small image such as a thumbnail, it is possible to also set parallax modification or two-dimensional display as a condition for displaying an image which is smaller than a predetermined size.

FIG. 26 is a flowchart illustrating a process in a case where the operation frame 112 is set as described in FIGS. 14 and 15. In step S902, in a case where it is determined that there is a screen where the image itself is operated using a touch panel or the like, the operation frame 112 is displayed in a two-dimensional manner in correspondence with the image in step S903. Due to this, the user operates the operation frame 112 using a finger or a pen, and since the finger or the pen is not positioned on the three dimensional image, it is possible to suppress the generation of a sense of incongruity due to the 3D image overlapping with the finger, the pen, or the like.

According to the embodiment described above, since there is no object displayed in front, it is possible to remove a portion, which has an unnatural relationship with a finger or a pen, in an image and it is possible to suppress an unpleasant sensation being imparted to the user. In addition, since the image which has parallax wider than the binocular width is not displayed, it is possible to suppress the same object being seen as double and it is possible to reliably suppress the user feeling a sense of incongruity.

The present disclosure contains subject matter related to that disclosed in Japanese Priority Patent Application JP 2010-253149 filed in the Japan Patent Office on Nov. 11, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
an input section where performing of input of an operation on a display image is possible using a multi-viewpoint image;
a parallax detection section which detects parallax of each image which configures the multi-viewpoint image; and
a parallax control section which adjusts parallax of the multi-viewpoint image in a case where it is at least possible to perform an operation on the display image using the input section.

2. The image processing device according to claim 1, further comprising:
a display section which displays the display image by irradiating light of the display image.

3. The image processing device according to claim 1,
wherein the parallax control section adjusts the parallax so that an image, which is seen in front of a display surface which irradiates the light of the display image, is seen on the display surface based on the parallax detected by the parallax detection section.

4. The image processing device according to claim 3,
wherein the parallax control section adjusts the parallax of an image which is seen in front of the display surface and adjusts the parallax so that another image is also moved to be behind the display surface.

5. The image processing device according to claim 3,
wherein the parallax control section modifies the parallax so that only an image, which is seen in front of the display surface, is seen on the display surface does not controlled and the parallax of other images.

6. The image processing device according to claim 1,
wherein the parallax control section adjusts so that an image, which is seen in front of the display surface which irradiates the light of the display image, is seen behind the display surface based on the parallax detected by the parallax detection section.

7. The image processing device according to claim 1,
wherein the parallax control section adjusts the parallax of the multi-viewpoint image to zero and sets the multi-viewpoint image as a two-dimensional image in a case where it is at least possible to perform an operation on the display image using the input section.

8. The image processing device according to claim 1, further comprising:
a proximity detection section which detects that a finger of an operator or an operating object is in the proximity of the display surface which irradiates the light of the display image,
wherein the parallax control section adjusts the parallax of the multi-viewpoint image in a case where the finger of the operator or the operating object is in the proximity using the proximity detection section.

9. The image processing device according to claim 8,
wherein the input section is configured of a capacitance touch sensor which is provided on the display surface, and
the proximity detection section is configured of the touch sensor and detects that the finger of the operator or the operating object is in the proximity based on a change in capacitance.

10. The image processing device according to claim 1,
wherein the parallax detection section determines whether or not a normal display is possible as a result of the adjustment of the parallax by the parallax control section, and
the image processing device further includes an image processing section which reduces the display image in a case where it is determined by the parallax detection section that normal display is not possible.

11. The image processing device according to claim 10,
wherein the image processing section reduces the image so that the parallax is equal to or less than the space between the eyes of a person in a case where it is determined by the parallax detection section that normal display is not possible.

12. The image processing device according to claim 1,
wherein the parallax control section adjusts the parallax of the multi-viewpoint image in a case where it is detected that the display image is to be enlarged due to an operation of the input section.

13. The image processing device according to claim 12,
wherein the parallax detection section determines whether or not a normal display is possible as a result of the adjustment of the parallax by the parallax control section, and
the image processing device further includes an image processing section which reduces the display image in a case where it is determined by the parallax detection section that normal display is not possible.

14. An image processing device comprising:
an input section where performing of input of an operation on a display image is possible using a multi-viewpoint image;
a parallax detection section which detects parallax of each image which configures the multi-viewpoint image; and
a parallax control section which adjusts parallax of the multi-viewpoint image in a case where the size of the display image is equal to or less than a predetermined value and which adjusts parallax so that an image, which is seen in front of a display surface which irradiates light of the display image, is seen on the display surface.

15. An image processing device comprising:
an input section where performing of input of an operation in the vicinity of a display image is possible using a multi-viewpoint image;
a parallax detection section which detects parallax of each image which configures the multi-viewpoint image; and
an image processing section which displays the input section in the vicinity of the display image using a two-dimensional image in a case where it is at least possible to perform an operation on the display image using the input section.

16. An image processing method comprising:
obtaining input of an operation performed on a display image displayed on a display section;
detecting parallax of each image which configures a multi-viewpoint image; and
adjusting parallax of the multi-viewpoint image in a case where it is at least possible to perform an operation on the display image using the input of an operation.

17. A program which is executed by a computer comprising:
obtaining input of an operation performed on a display image displayed on a display section;
detecting parallax of each image which configures a multi-viewpoint image; and
adjusting parallax of the multi-viewpoint image in a case where it is at least possible to perform an operation on the display image using the input of an operation.
